(19) United States
(12) Patent Application Publication
(10) Pub. No.: US 2014/0198071 A1
(43) Pub. Date: Jul. 17, 2014

(54) Force Sensing Touchscreen

(71) Applicant: Cherif Atia Algreatly, Palo Alto, CA (US)

(72) Inventor: Cherif Atia Algreatly, Palo Alto, CA (US)

(73) Assignee: Cherif Atia Algreatly, Newark, CA (US)

(21) Appl. No.: 14/169,822

(22) Filed: Jan. 31, 2014

Related U.S. Application Data
(63) Continuation-in-part of application No. 12/587,339, filed on Oct. 6, 2009, now Pat. No. 8,711,109.

(51) Int. Cl. G06F 3/041

(52) U.S. Cl. CPC G06F 3/0414
USPC 345/173

(57) ABSTRACT

A touchscreen that determines the point of touch and magnitude of a force applied to the touchscreen is disclosed. The force can be perpendicular, parallel, or sloped with respect to the touchscreen surface. The force can also be a plurality of forces simultaneously applied to the touchscreen surface where the centroid and resultant of the plurality of forces are determined. The touchscreen can take the form of various two-dimensional or three-dimensional shapes such as a circle, cube, sphere, cylinder, or the like.

### CROSS-REFERENCE TO RELATED APPLICATION

This application is a continuation-in-part of a U.S. patent application Ser. No. 12/587,339, filed Oct. 6, 2009, titled “Touch Sensing Technology”.

### BACKGROUND

Different technologies are used in touchscreens, including capacitive, resistive, infrared, and acoustic wave. While some of these technologies can sense the position of touch between a touching panel and an object touching the touching panel, they cannot always sense the magnitude of the force applied by the object to the touching panel at the moment of touch. Sensing the magnitude of the force can be utilized in various computer applications. For example, it can be used to provide the computer system with an immediate input representing a speed of movement in a gaming application, a depth of a third dimension in a 3D application, a size or color transparency of an object in a graphics application, or the like.

There are a number of US patents and patent applications that disclose the use of force sensing in touchscreens to determine the magnitude of a pressure or force applied against a touchscreen. For example, the U.S. Pat. No. 7,196,694 of 3M INNOVATIVE PROPERTIES COMPANY discloses a device for determining the position and magnitude of a force applied to a touch screen. The device includes a plurality of beam members or strips, each of which is connected, from its bottom side, to two supports with one or more force sensors. When a force is applied to the top of the beam member, the force passes to the two supports and is detected by the one or more force sensors.

The U.S. patent application Ser. No. 12/939,078 of QUALCOMM INCORPORATED proposes using a plurality of force sensors around the bottom perimeter of a touching panel. When a force is applied to the top side of the touching panel, the force passes to the bottom perimeter of the touching panel to be detected by the force sensors. Also, the U.S. patent application Ser. No. 12/725,699 of MOTOROLA INCORPORATION suggests using a combination of two layers of surfaces located on top of each other. The first layer is a touchscreen surface to detect the position of touch, and the second layer is a force sensing surface to detect the magnitude of the force applied at the position of touch. The two layers or surfaces combined provide the computer system with an immediate input representing the point of touch and the magnitude of the force applied to the touchscreen.

However, there are several disadvantages related to the design and method of how the force sensors are utilized in the touchscreens of the aforementioned issued patent and patent applications. The first disadvantage is that the force sensors can only detect the perpendicular force applied to the touchscreen in one direction. For example, if the touchscreen is positioned on a flat surface parallel to the xy-plan, the user can apply a force in the negative z-axis to the touchscreen, but cannot apply a force in the positive z-axis. Accordingly, it is possible to gradually increase the force applied to the touchscreen, but it is impossible to gradually decrease the force applied to the touchscreen when the touchscreen is initial touched.

The second disadvantage in the aforementioned cases, is that the force sensors cannot detect the force applied parallel to the touchscreen. This is limiting, as a parallel force applied to the touchscreen surface could be of considerable importance in many computer applications, in comparison to the perpendicular force acted on the touchscreen. For example, it is easy to apply two parallel forces to the touchscreen, where the two parallel forces are in two opposite directions relative to each other. The two opposite and parallel forces to the touchscreen can be along the negative x-axis and the positive x-axis; or along the negative y-axis and the positive y-axis of the touchscreen plane. Parallel force applied to the touchscreen can follow various directions in the xy-plane to represent different inputs. For example, the parallel forces can be aligned to zero and 180 degrees, 90 and 270 degrees, 45 and 225 degrees, or 135 and 325 degrees to represent increasing or decreasing four different inputs. These four results can be achieved without changing the point of touch of the finger on the touchscreen, opposite to the perpendicular force which is incapable of achieving this function.

The third disadvantage of using the force sensing mechanism of the aforementioned issued patent and patent applications, is the inaccuracy of determining the force magnitude when the force is applied in a downward 3D-diagonal direction relative to the touchscreen surface. This is based on a model which structurally represents the force by a first force parallel to the touchscreen surface, and a second force perpendicular to the touchscreen surface. The first force is then neglected where it cannot be sensed by the force sensors, while the second force is sensed by the force sensors. In this case, the value of the second force is always less than the value of the original force. This confuses the user when s/he applies more force with his/her finger to the touchscreen without seeing any effect in his/her input displayed by the computer display, especially when the tilted direction of the finger is closer to the touchscreen plane.

The fourth disadvantage is related to the deficiency of each one of the above mentioned patent and patent applications. For example, the technique of the U.S. Pat. No. 7,196,694 of 3M INNOVATIVE PROPERTIES COMPANY divides the touchscreen into a plurality of strips in the form of beam members which complicates the design and the manufacturing of the touchscreen. The U.S. patent application Ser. No. 12/939,078 of QUALCOMM INCORPORATED uses a large number of force sensors which increases the cost of the touchscreen especially bigger sized touchscreens. The U.S. patent application Ser. No. 12/725,699 of MOTOROLA INCORPORATION utilizes two layers or surfaces on top of the computer display which affects the clarity of the digital data presented on the computer display, in addition to, increasing the cost of the touchscreen.

There is a need for a new technology for touchscreens that detects the forces applied to the touchscreen whether this force is perpendicular, parallel, or sloped relative to the touchscreen surface. This technology should be simple and utilize a minimum number of force sensors thus lowering costs, and also increasing the clarity of the digital data presented on the computer display.

### SUMMARY

In one embodiment, the present invention discloses a force sensing touchscreen that detects both of the position of touch and the magnitude of the force applied to the touchscreen regardless of the direction of the force relative to the touchscreen surface. For example, the present invention determines the perpendicular force in relation to the touchscreen surface, whether this force is along the positive or negative z-axis. This is not the case with the prior art of touchscreens which only detect the perpendicular force along the negative z-axis. Also, the present invention detects the parallel force to the touchscreen surface, where this parallel force cannot be detected by any of the prior art technologies. Moreover, the present invention detects the accurate magnitude of the sloped force on the touchscreen surface, which is a unique feature relative to other available technologies that cannot detect the accurate magnitude of the sloped force.

In another embodiment, the present invention determines the resultant and the centroid of multiple forces simultaneously applied to a touchscreen. The multiple forces can be in different three-dimensional directions relative to the touchscreen surface, and also relative to each other. For example, some of the multiple forces can be perpendicular to the touchscreen surface, and others can be parallel to the touchscreen surface, while one or more of the multiple forces can be sloped relative to the touchscreen surface. In this case, the centroid of the multiple forces is represented by a point located on the touchscreen, while the resultant of the multiple forces is represented by a magnitude along a three-dimensional direction.

Overall, the design of the present invention is straightforward, and the number of the force sensors utilized in the touchscreen is minimum, which simplifies the manufacturing process and reduces the cost of the present invention. Additionally, the present invention of force sensing touchscreen can take different two-dimensional shapes such as a rectangle, triangle, circle, or the like. It can also take the form of various three-dimensional shapes such as a cube, sphere, cylinder, pyramid, or the like. Adding variation to shapes of touchscreens opens the door for new software applications and utilization of touchscreen technologies. Also, the force sensors utilized in the present invention have no impact on the clarity of the digital data presented on the computer display, allowing the user a crisp visual experience.

Generally, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a vertical force applied to a surface connected to four force sensors that are positioned parallel to the surface plane.

FIG. 2 illustrates the top view of the surface where the locations of the four force sensors and the force are shown in the figure.

FIG. 3 illustrates a horizontal force applied to a surface connected to four force sensors that are positioned perpendicular to the surface plane.

FIG. 4 illustrates the top view of the surface, where the locations of the four force sensors and the force are shown in the figure.

FIG. 5 illustrates a force in a three-dimensional direction applied to a surface where four force sensors are positioned parallel to the surface plane, and another four force sensors are positioned perpendicular to the surface plane.

FIG. 6 illustrates the top view of the surface, where the locations of the eight force sensors and the force are shown in the figure.

FIG. 7 illustrates four force sensors utilized in a touchpad to detect the point of touch between the touchpad and a user's finger, according to one embodiment of the present invention.

FIG. 8 illustrates four force sensors utilized in a touchscreen to detect the point of touch between the touchscreen and an object, according to one embodiment of the present invention.

FIG. 9 illustrates four force sensors utilized in a computer mouse to detect the mouse movement on a surface, according to one embodiment of the present invention.

FIG. 10 illustrates eight force sensors utilized in a keyboard button to detect the three-dimensional direction of a finger touching the keyboard button, according to one embodiment of the present invention.

FIG. 11 illustrates six force sensors utilized with a cube to detect the point of touch, and the magnitude and three-dimensional direction of a force exerted by a finger on the cube.

FIG. 12 illustrates six force sensors utilized with a sphere to detect the point of touch, and the magnitude and three-dimensional direction of a force exerted by a finger positioned inside the sphere.

FIG. 13 illustrates multiple forces simultaneously applied by a hand to a touchscreen where the centroid and resultant of the multiple forces are determined.

FIG. 14 illustrates multiple forces simultaneously applied by the left hand and a finger of the right hand to a touchscreen where the centroid and resultant of the multiple forces are determined.

FIG. 15 illustrates the centroid and resultant of multiple forces simultaneously applied to a surface.

FIGS. 16 to 17 illustrate different two-dimensional shapes of force sensing touchscreens, according to one embodiment of the present invention.

FIGS. 18 to 20 illustrate using a frame to support one or more touchscreens with curved boundaries.

FIG. 21 illustrates the manner of positioning the force sensors at a corner of a force sensing touchscreen, according to one embodiment of the present invention.

FIGS. 22 to 26 illustrate different three-dimensional shapes of force sensing touchscreens according, to one embodiment of the present invention.

FIG. 27 illustrates the three-dimensional frame attached to a sphere to turn it into a touchscreen.

### DETAILED DESCRIPTION

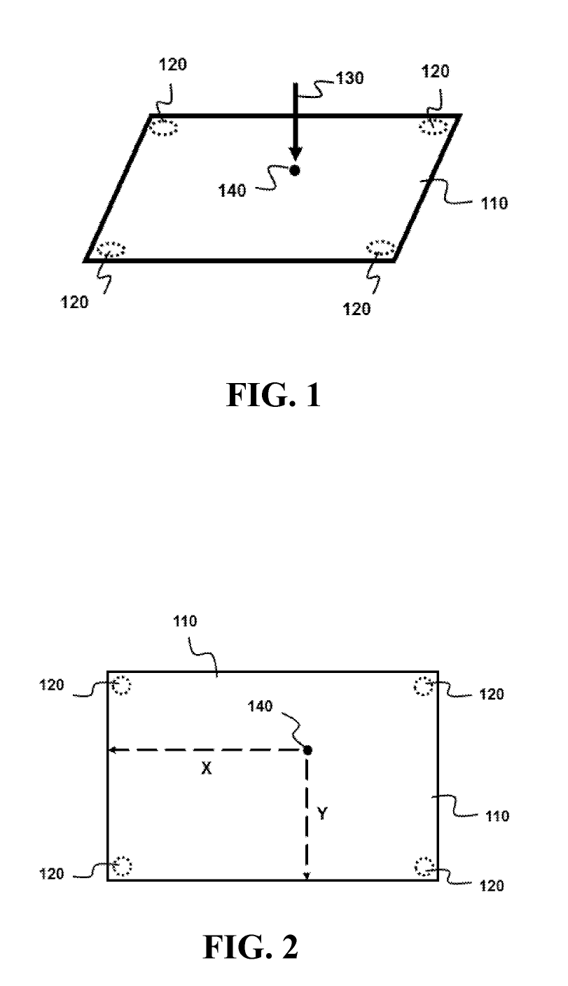

To clarify the concept of the present invention, FIG. 1 illustrates a touch surface 110 which is a rectangular surface positioned to be parallel to the xy-plane on four force sensors 120 that are located beneath the four corners of the touch surface, where a vertical force 130 is exerted on the touch surface at a touch point 140. FIG. 2 illustrates a top view for the touch surface and the four force sensors of FIG. 1, where x and y represent the Cartesian coordinates of the touch point relative to an origin which is the left bottom corner of the touch surface.

The value of the vertical force can be computed by adding the four values of the four forces or reactions that are exerted at the positions of the four force sensors, whereas these four reactions represented by the output of the four force sensors. The position of the touch point can be computed by solving the equilibrium equations of the vertical force and the four reactions of the four force sensors as will be described subsequently. When the vertical force is moved on the touch surface the successive positions of the points of touch can be computed to represent the path of the vertical force movement on the touch surface. The vertical force can be any object that has a weight or applies a pressure such as a user's finger, a pen, or the like.

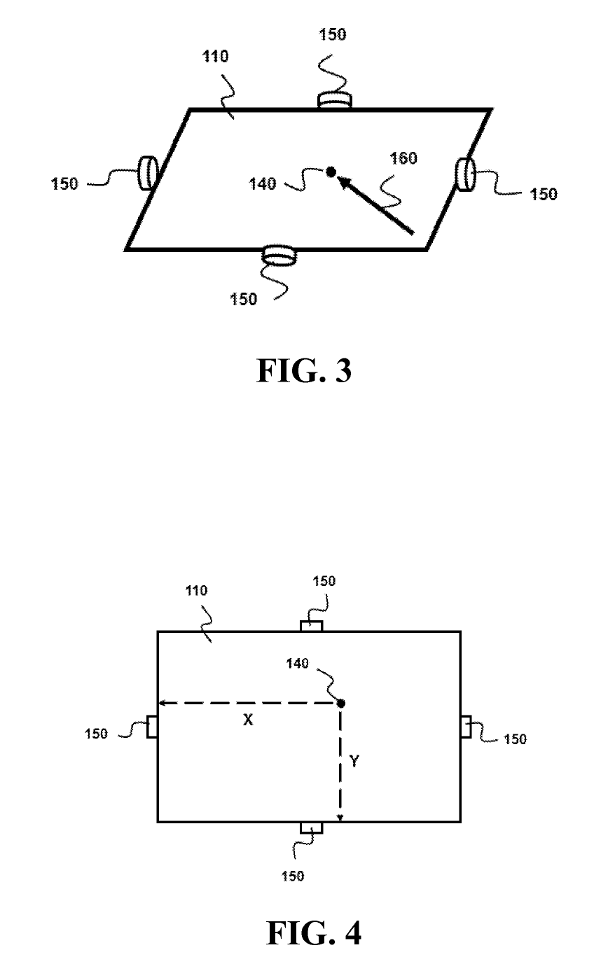

FIG. 3 illustrates another form of the present invention where the touch surface 110 is positioned between four force sensors 150 that are located at the middle points of the touch surface sides as shown in the figure, while a horizontal force 160 is exerted on the touch surface at the same touch point 140 of FIG. 1. FIG. 4 illustrates a top view for the touch surface and the four force sensors of FIG. 3, where x and y represent the Cartesian coordinates of the touch point relative to an origin which is the left bottom corner of the touch surface. Generally, the value of the horizontal force and its direction relative to the x-axis can be computed by analyzing the four forces that are exerted at the positions of the four force sensors, whereas these four force represented by the output of the four force sensors as will be described subsequently.

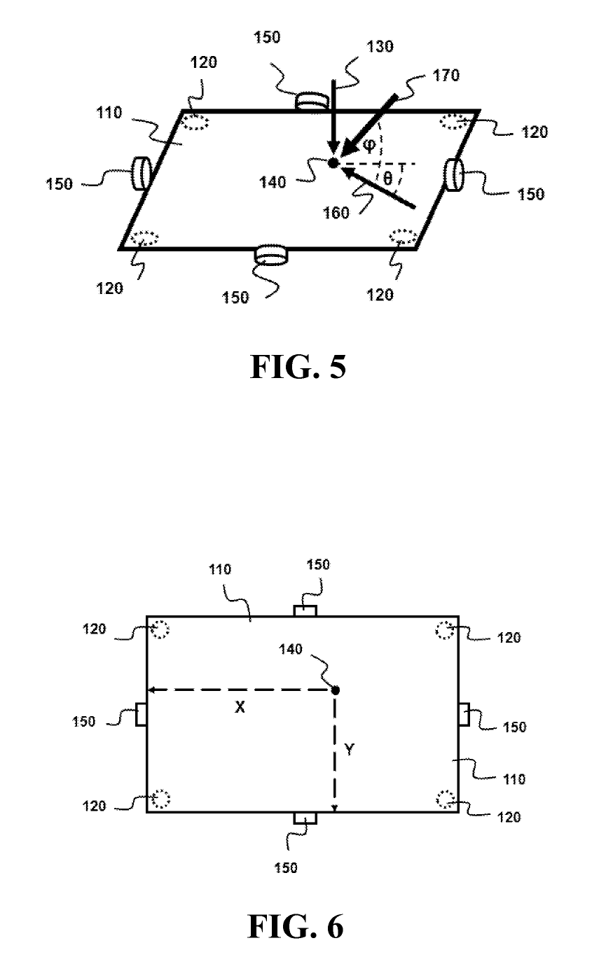

FIG. 5 illustrates combining the elements of FIGS. 1 and 3 together to present the touch surface, the four touch sensors 120 that are positioned vertically beneath the touch surface corners, and the four touch sensors 150 that are positioned horizontally at the middle points of the touch surface sides. The vertical force 130 and the horizontal force 160 can be combined into one resultant force 170 that touches the touch surface at the same touch point 140. As shown in the figure, θ represents the angle between the positive x-axis and a line representing the projection of the resultant force on the xy-plan, while φ represents the angle between the resultant force and the xy-plane. FIG. 6 illustrates a top view for the elements of FIG. 5. Generally, the values of the vertical force, the horizontal force, and the resultant force, in addition to, the values of θ, φ, x, and y can be computed using a specific algorithm as will be described subsequently.

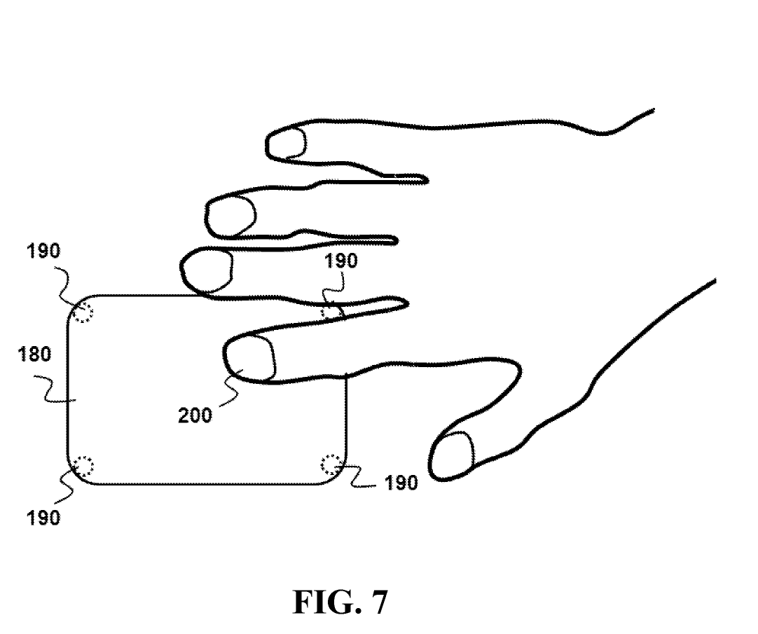

Overall, the concept of utilizing the force sensors can be implemented in various computer input devices. For example, FIG. 7 illustrates a touchpad comprised of a rectangular touch surface 180 where four force sensors 190 are positioned vertically beneath the four corners of the rectangular touch surface to be connected to a microprocessor. As shown in the figure, the user's finger touches the rectangular touch surface at a touch point 200, where the four force sensors provide the microprocessor with four signals that can be analyzed to compute the position of the touch point and the value of the vertical force.

The present touchpad has many advantages in comparison to the traditional touchpad. For example, the magnitude of the vertical force can be utilized to represent the speed of moving objects on the computer display without utilizing additional buttons or using another finger. Moreover, in case of adding four force sensors to the boundary sides of the rectangular touch surface, as described previously, then the touchpad can detect the 3D direction of the exerted force which can be utilized to manipulate the objects to move in 3D on the computer display.

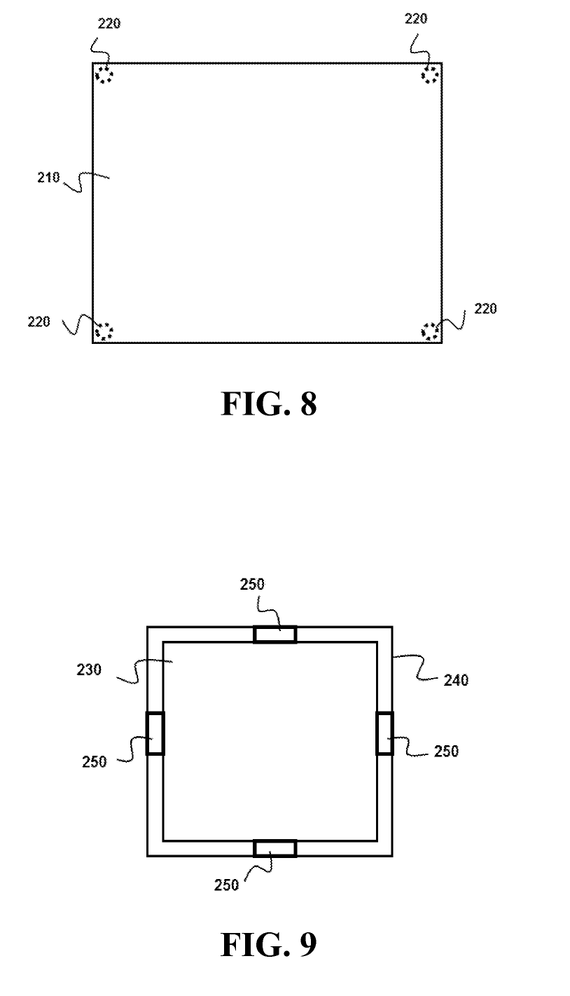

FIG. 8 illustrates a portable touch screen comprised of a transparent sheet 210 which is a thin flexible sheet attached to four force sensors 220 at its four corners where the four sensors can be attached to the corners of a computer display and connected to the computer by a USB. When the user's finger touches the portable touch screen the transparent sheet compacts to exert tension forces on its four corners where the values of these tension forces are detected by the four force sensors, and provided to a microprocessor that computes the position of the user's finger along the transparent sheet. The portable touch screen is a unique computer input device that converts the traditional computer display into a touch screen in a fast and simple manner.

FIG. 9 is a top view of a computer mouse comprised of; a top chassis 230, a bottom chassis 240 and four force sensors 240 located between the top chassis and the bottom chassis of the mouse. The user's hand holds the top chassis to exert a horizontal force in a specific direction on the mouse without moving it on a desk or surface, where the four force sensors provide four signals to a microprocessor representing the exerted forces on the four sides of the bottom chassis. The microprocessor receives the signals from the four force sensors and provides the computer system with an immediate input representing the direction of the exerted force on the mouse which manipulates the objects to move in the same direction on the computer display. In this case, the magnitude of the exerted force can be utilized to control the speed of moving the objects on the computer display.

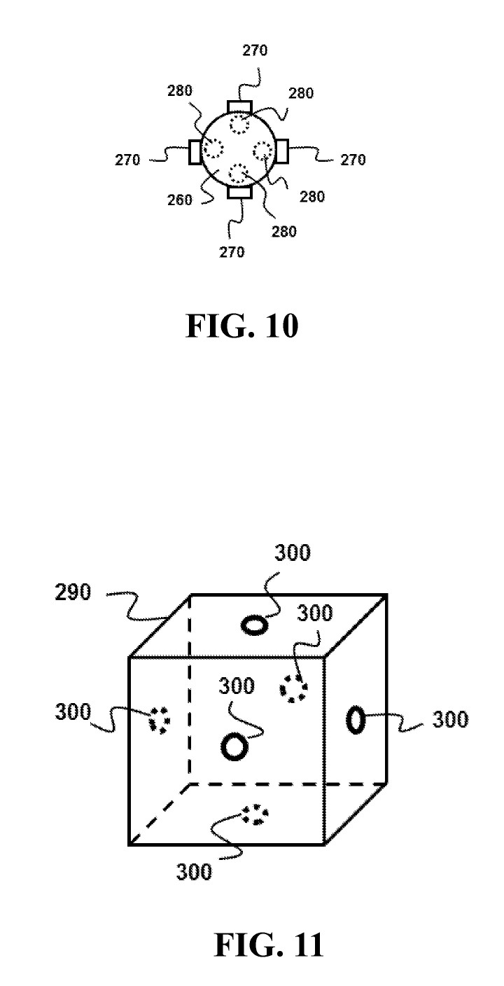

FIG. 10 illustrates a keyboard button 260 comprised of; a first group of four force sensors 270 positioned to face the side surface of the keyboard button, and a second group of four force sensors 280 positioned beneath the keyboard button. As described previously this configuration of force sensors enables such keyboard button to detect the direction of the exerted force from the finger on the keyboard button when typing. Each different direction of said exerted force can be interpreted to provide the computer system with a unique input or a keyboard shortcut using one button only.

The idea of using the force sensors can be implemented in various 3D computer input devices that enable the user to manipulate the objects to move in 3D on the computer display. For example, FIG. 11 illustrates a cube 290 where each one of its faces is connected to a force sensor 300 as shown in the figure. The cube can be moved slightly while the force sensors can not be moved from their positions, accordingly, when a user pushes the cube in a 3D direction the output of the force sensors can be analyzed to compute this 3D direction. The direction of pushing the cube in 3D represents the same direction of moving the objects in 3D on the computer display.

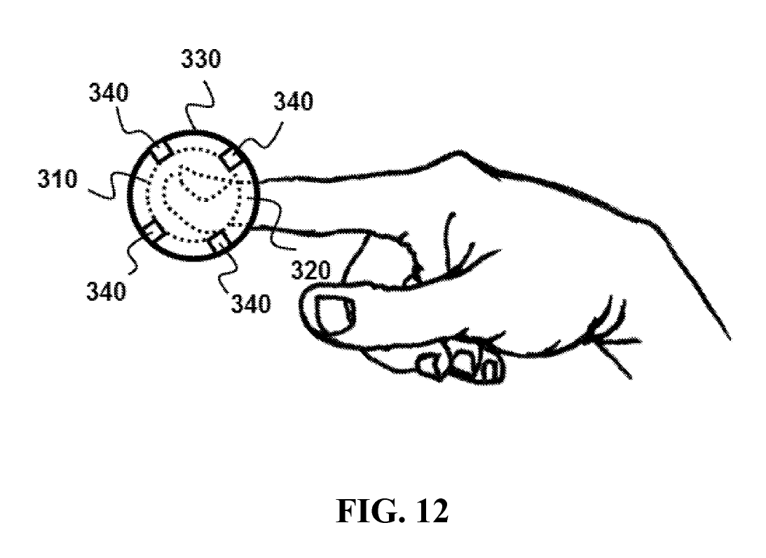

FIG. 12 illustrates another innovative 3D input device that looks like a 3D pointing stick comprised of an interior sphere, an exterior sphere, and six force sensors. The interior sphere 310 is a hallow sphere that has an opening 320 to enable the user to insert his/her finger inside it, where this interior sphere is filled with an elastic material such as rubber. The exterior sphere 330 is a hallow sphere surrounds the interior sphere and fixed to an object to prevent it form moving with the movement of the interior sphere. The six force sensors 340 are located between the interior sphere and the exterior sphere to detect the movement of the interior sphere with the finger movement in three dimensions. The direction of moving or rotating the finger along/about the x, y, or z-axis inside the interior sphere represents the same direction of moving or rotating the objects along/about the x, y, or z-axis on the computer display.

Overall, the main advantage of the present invention is utilizing an existing hardware technology that is simple and straightforward which easily and inexpensively carry out the present touch sensing touchscreen. For example, the force sensor can be a digital force sensor or an analog force sensor that detects the exerted force on its surface and generates a signal representing the value of this force. The two commercially available force sensors in the market are in the form of a push button and a fixable strip where both of them can be easily utilized with the present invention. The microprocessor receives the signal of the force sensors and provides the computer system with an immediate input representing a movement in two or three-dimensions on the computer display.

The algorithm of the present touch sensing technology depends on structurally analyzing the output of the force sensors to compute the position, the magnitude, and/or the direction of the force that is exerted form an object on the touch surface. Generally, as described previously the elements of the present touch sensing touchscreen has three different structural forms. The first structural form is illustrated in FIG. 1 where a vertical force is exerted on four vertical force sensors. The second structural form is illustrated in FIG. 3 where a horizontal force is exerted on four horizontal force sensors. The third structural form is illustrated in FIG. 5 where a force that can be analyzed into a vertical force and a horizontal force is exerted on four vertical force sensors and four horizontal force sensors.

According to the structure analysis of the elements of FIG. 1 there are three unknown values and six known values. The three unknown values are the value of the vertical force, and x, and y, while the six known values are the four vertical reactions of the four sensors, and the length and width of the touch surface. Structurally analyzing the elements of FIG. 1 enables computing the three aforementioned unknown values. For example, the vertical force will be equal to the four reactions of the four force sensors, while the values of x and y can be obtained by solving two equilibrium equations of the vertical force and the four reactions of the four force sensors at any two corners of the touch surface. Generally, the following two equations represent the values of vertical force, and x and y;

Fv=R1+R2+R3+R4

y=(0.5 W−(LR2+WR4+(L²+W²)·^{0.5}R3)²/2WFv²)+(WR1+LR3+((L²+W²)^{0.5}R2)²/2WFv²

x=(((WR1+LR3+(L²+W²)^{0.5}R2)²/Fv²)−y²)^{0.5}

In the previous equations, “Fv” represents the value of the vertical force. R1 represents the reaction of the first force sensor that is located on the upper left corner, R2 represents the reaction of the second force sensor that is located on the upper right corner, R3 represents the reaction of the third force sensor that is located on the lower right corner, and R4 represents the reaction of the fourth force sensor that is located on the lower left corner of the touch surface. “x” and “y”, respectively, represent the horizontal distance and the vertical distance of the vertical force relative to the left bottom corner of the touch surface. “L” represents the length of the touch surface, and “W” represents the width of the touch surface.

According to the structure analysis of the elements of FIG. 3 there are two unknown values and six known values. The two unknown values are the value of the horizontal force, and its direction relative to the positive x-axis, and the four known values are the four horizontal reactions of the four force sensors. Structurally analyzing the elements of FIG. 3 enables computing the two aforementioned unknown values. For example, if the direction of the horizontal force is located between the first force sensor and the second force sensor then;

tan θ=R1/R2 and Fh=R1/sin θ

If the direction of the horizontal force is located between the first force sensor and the fourth force sensor then;

tan (θ−90)=R4/R1 and Fh=R4/sin (θ−90)

If the direction of the horizontal force is located between the third force sensor and the fourth force sensor then;

tan (θ−180)=R3/R4 and Fh=R3/sin (θ−180)

If the direction of the horizontal force is located between the second force sensor and the third force sensor then;

tan (θ−270)=R2/R3 and Fh=R2/sin (θ−270)

In the previous equations, “Fh” represents the value of the horizontal force. R1, R2, R3, and R4 represent the four reactions of the four force sensors that are, respectively, located at the top side, right side, bottom side, and left side of the touch surface, while 0 represents the angle between the horizontal force and the positive of the x-axis.

According to the structure analysis of the elements of FIG. 5, the force 170 can be analyzed into a vertical force 130 and a horizontal force 160. The value of the vertical force and its position along the touch surface can be computed according to the previous equations of FIG. 1, while the value of the horizontal force and its direction relative to the positive x-axis can be computed according to the previous equations of FIG. 3. Knowing the value of the vertical force and the value of the horizontal force enables computing the value of “φ” which represents the direction of the force relative to the xy-plan according to the following equation;

tan φ=Fv/Fh

F=Fv/sin φ

It is important to note that in case of using the portable touch screen of FIG. 8, the user's finger makes the transparent sheet compact to exert tension forces on the four force sensors that are attached to the corners of the transparent sheet instead of exerting compression forces on the four force sensors as the case of FIG. 1. Also when utilizing the cube and the six force sensors of FIG. 11, in this case the exerted force on the cube will be analyzed in three directions along the x, y, and z-axis instead of analyzing it in two direction only as the case of FIG. 3. This rule of analyzing the force in three directions along the x, y, or z-axis is also applied on the 3D pointing stick of FIG. 12.

It is also important to note that the touchpad of FIG. 7 and the portable touch screen of FIG. 8 can detect the position of one finger only. To enable the touchpad and the portable touch screen to detect the positions of more than one finger, in this case, the number of the force sensors is increased. Increasing the number of the force sensors increases the number of the known variables in the equilibrium equations which enables computing more unknown variables such as the positions of more than one force or finger. In one embodiment, the present invention is utilized as an additional layer positioned on top of a multi-touch touchscreen. In this case, the multi-touch touchscreen detects the positions of touch while the present invention detects the magnitude and 3D directions of the forces applied to the multi-touch touchscreen.

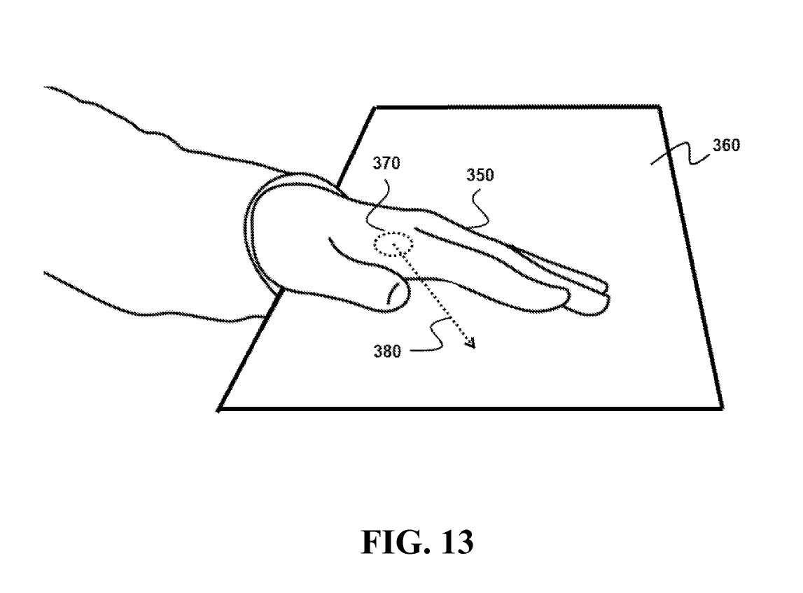

In another embodiment, the present invention determines the centroid and resultant of a plurality of forces simultaneously applied to a surface. For example, FIG. 13 illustrates a user's hand 350 applying a plurality of forces to a surface 360. The plurality of forces is generated from the multiple points of touch between the palm and five fingers of the hand, and the surface. As shown in the figure, the centroid 370 of the plurality of forces, which is represented by a point or spot located on the surface, is determined. Also, the resultant 380 of the plurality of forces is determined. The resultant is represented by a magnitude of a final force and a three-dimensional direction of this magnitude. This three-dimensional direction can be described by a first angle located between a line representing the magnitude and the surface plane, and a second angle located between the projection of the line on the surface plane and the x-axis of the surface plane.

Determining the centroid and resultant of a plurality of forces simultaneously applied to a surface can be utilized in various computer applications. For example, in a gaming application, touching the touchscreen with a hand while applying forces by the hand to the touchscreen in a 3D direction provides the computer system with an input representing a movement of an object in the same 3D direction on the computer display. In this case, the centroid of the forces of the hand represents the point of touching the object on the computer display, and the resultant of the forces represents the pressure of pushing the object to move in the 3D direction on the computer display.

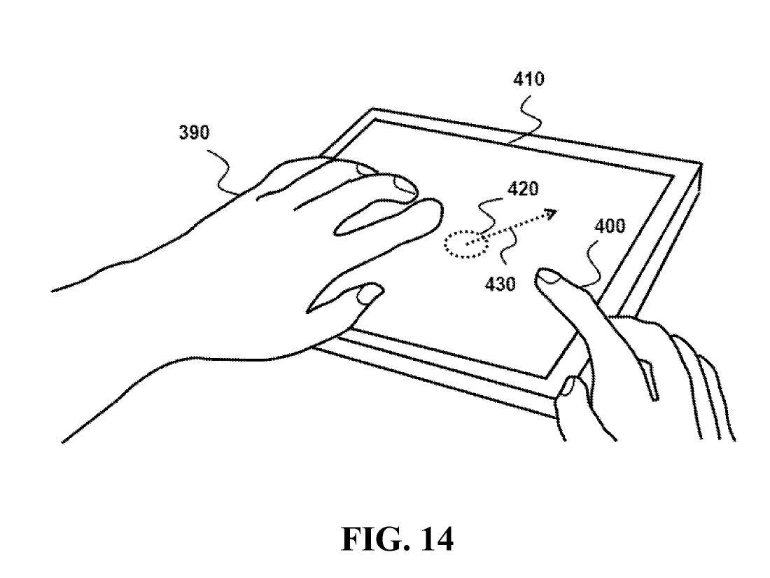

FIG. 14 illustrates another example of determining the centroid and resultant of a plurality of forces applied to a surface. In this case, the left hand 390 and a finger 400 of the right hand are applying a plurality of forces to the surface 410. As shown in the figure, the spot 420 represents the centroid of the plurality of forces, and the arrow 430 represents the resultant of the plurality forces. The use of two hands to simultaneously apply multiple forces to the touchscreen of the present invention can also be utilized in various gaming applications, as mentioned previously.

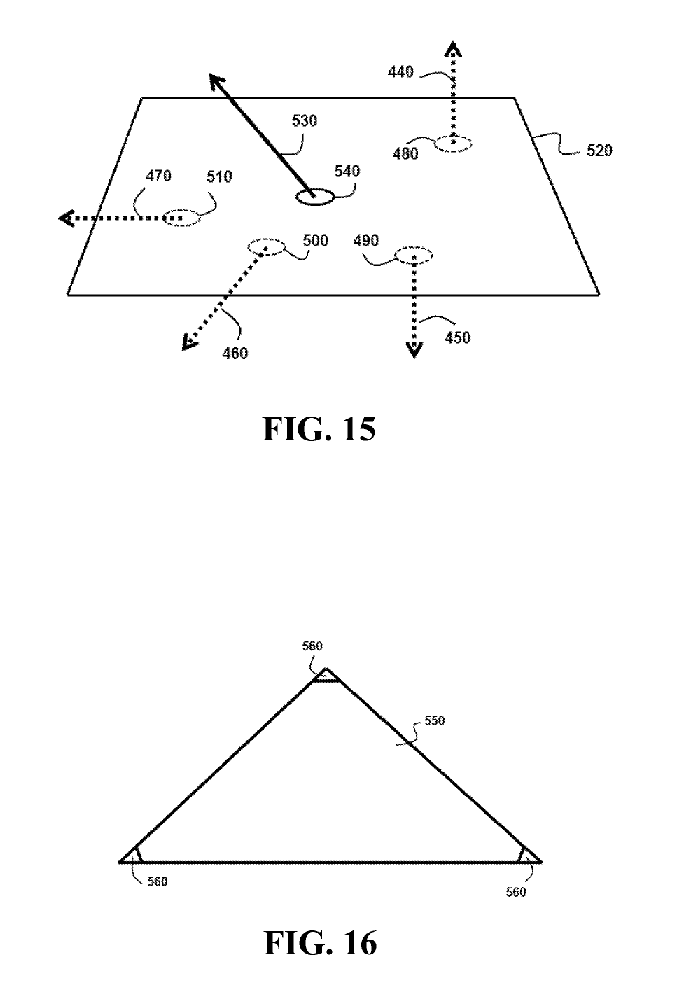

FIG. 15 illustrates four forces 440-470 simultaneously exerted in four locations 480-510 on a surface 520. The arrow 530 represents the resultant of the four forces, and the spot 540 represents the centroid of the four forces. As shown in the figure, the force 440 is perpendicular to the surface along the positive z-axis. The force 450 is perpendicular to the surface along the negative z-axis. The force 460 is sloped to the surface, and the force 470 is parallel to the surface. In this case, the resultant of the four forces is sloped to the surface, while in some other cases the resultant could be perpendicular or parallel to the surface according to the forces directions.

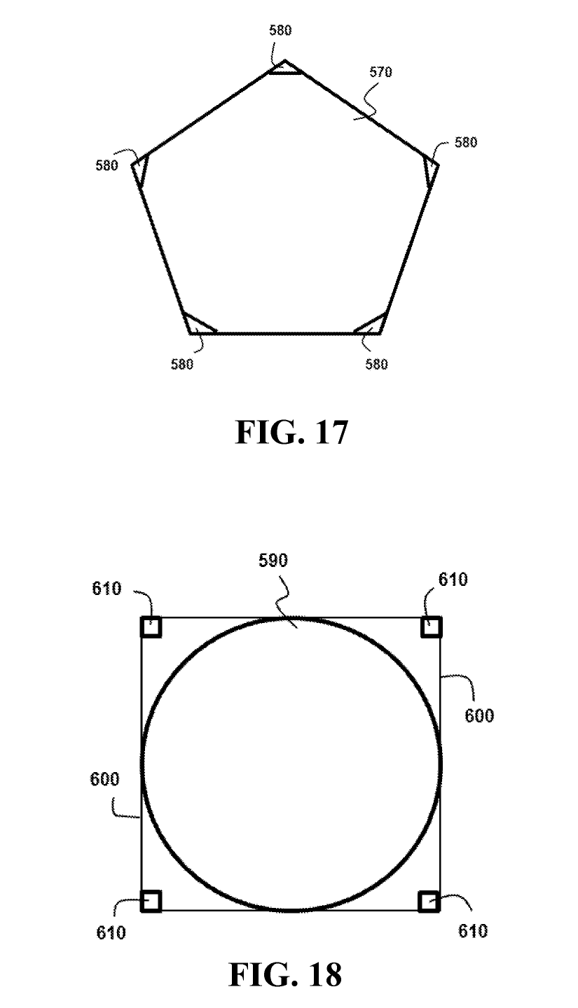

Generally, the concept of positioning a force sensor at each corner of the touchscreen surface can be utilized in creating various innovative shapes of touchscreens. For example, FIG. 16 illustrates a touchscreen in the form of a triangle 550 where three force sensors 560 are positioned on the three corners of the touchscreen. FIG. 17 illustrates a touchscreen in the form of a pentagon 570 where five force sensors 580 are positioned at the five corners of the pentagon. FIG. 18 illustrates a touchscreen in the form of a circle 590 attached to a square frame 600 where four force sensors 610 are positioned on the four corners of the square frame.

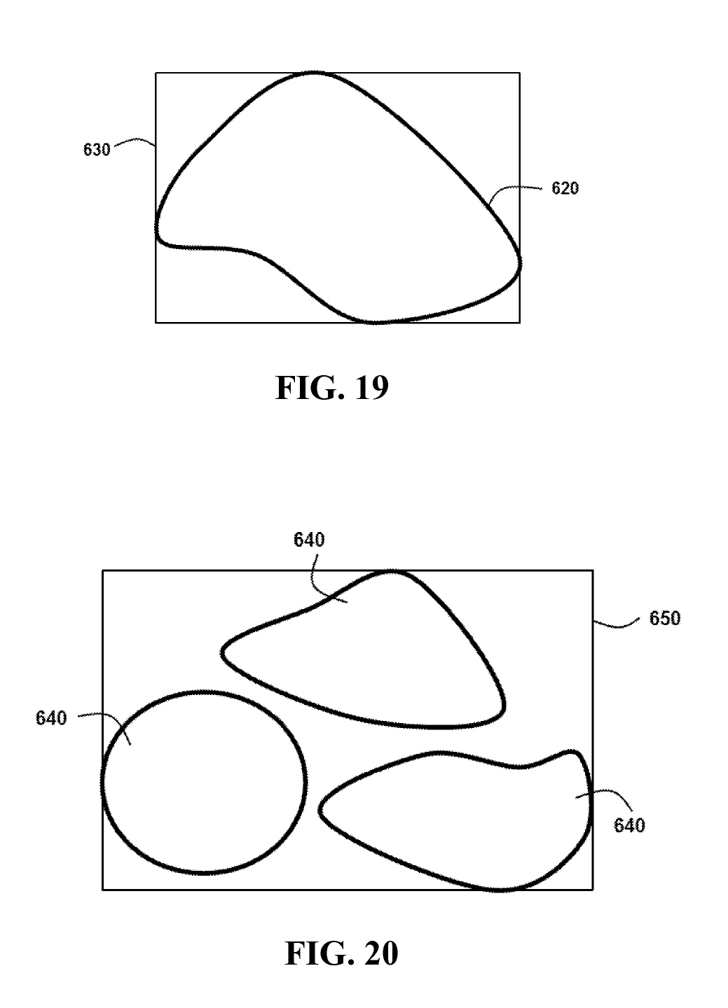

The square frame can be used with a variety of shapes such as circles, pentagons, hexagons, or octagons to reduce the number of sensors to four sensors positioned at the four corners of the square frame. The triangular frame can also be used in place of the square frame to reduce the number of the sensors needed to three sensors positioned at the three corners of the triangular frame. Utilizing a frame to support the touchscreen can be used to create touchscreens with more complicated shapes. For example, FIG. 19 illustrates a touchscreen with a curved boundary 620 positioned on a rectangular frame 630. FIG. 20 illustrates a plurality of touchscreen 640 with curved boundaries positioned on a single rectangular frame 650. In this example, four sensors only can be used with the plurality of touchscreens, at the rectangular corners, which inexpensively carries out the functions present invention.

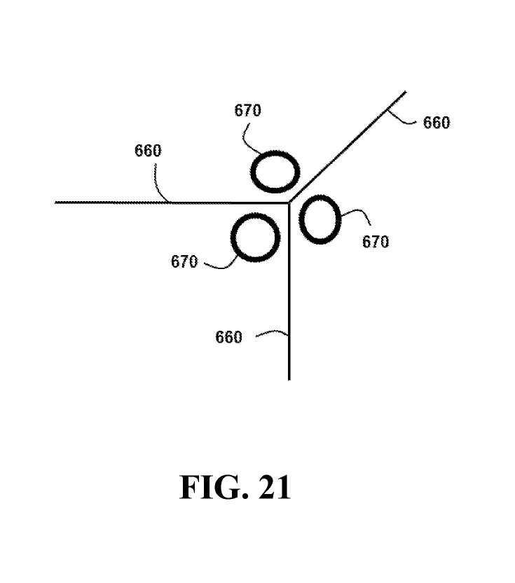

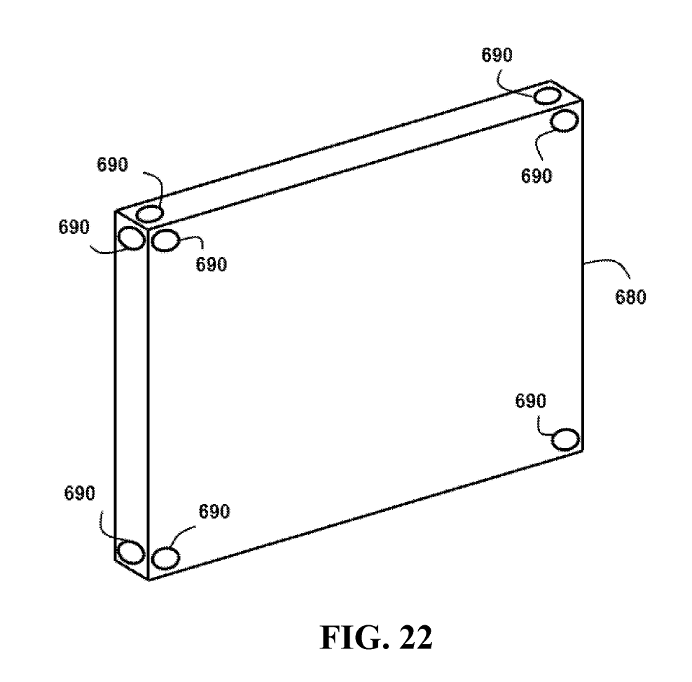

FIG. 21 illustrates the manner of positioning the force sensors at the corners of the touchscreens. As shown in the figure, three surfaces 660 are meeting at one corner where a force sensor 670 is positioned at each corner of a surface. Using this technique or configuration at the corners of the touchscreen enables the creation of innovative 3D shapes of touchscreens. For example, FIG. 22 illustrates a touchscreen 680 in the form of a panel with two faces and four edges. As shown in the figure, the two faces and four edges are considered as six surfaces, where a force sensor 690 is positioned at the corner of each surface. Positioning the force sensors at the corners of the touchscreen allows better visualization of the computer display since the majority of the computer display will be free of force sensors.

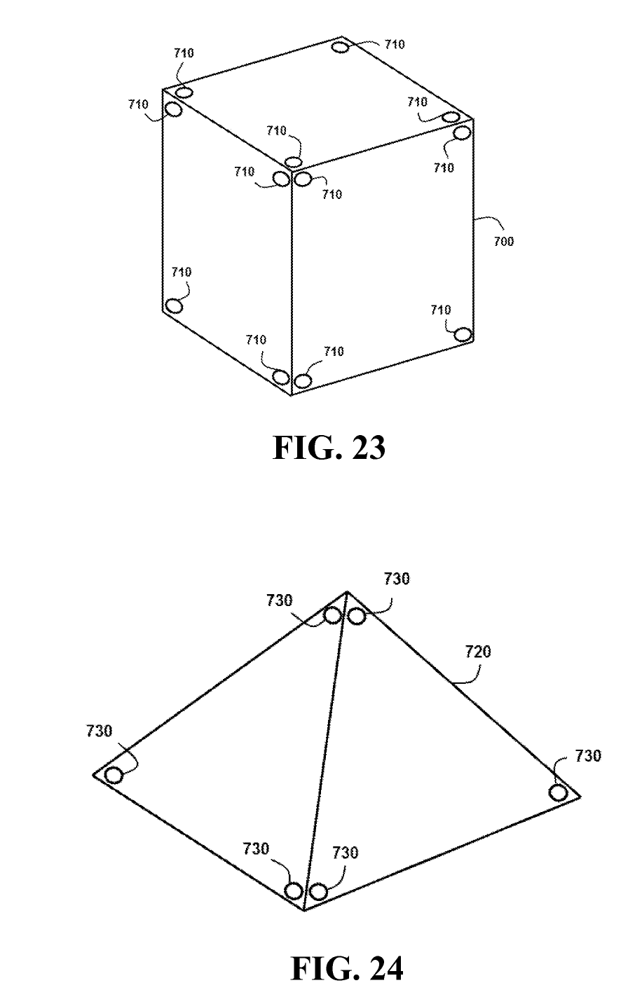

FIG. 23 illustrates a touchscreen in the form of a cube 700 where a force sensor 710 is positioned on each corner of a face of the cube. In this case, the six faces of the cube can function as six computer displays attached to each other. The point of touch on any face of the cube, and the magnitude of the force applied to the cube can be determined as described previously. This enables the user to interact with the three-dimensional computer application presented on the six faces of the cube. FIG. 24 illustrates another touchscreen in the form of a pyramid 720 where a force sensor is positioned at each corner of a surface of the pyramid. Once the user touches the pyramid at any point, the point of touch and the magnitude of the force applied to the point of touch are determined as described previously.

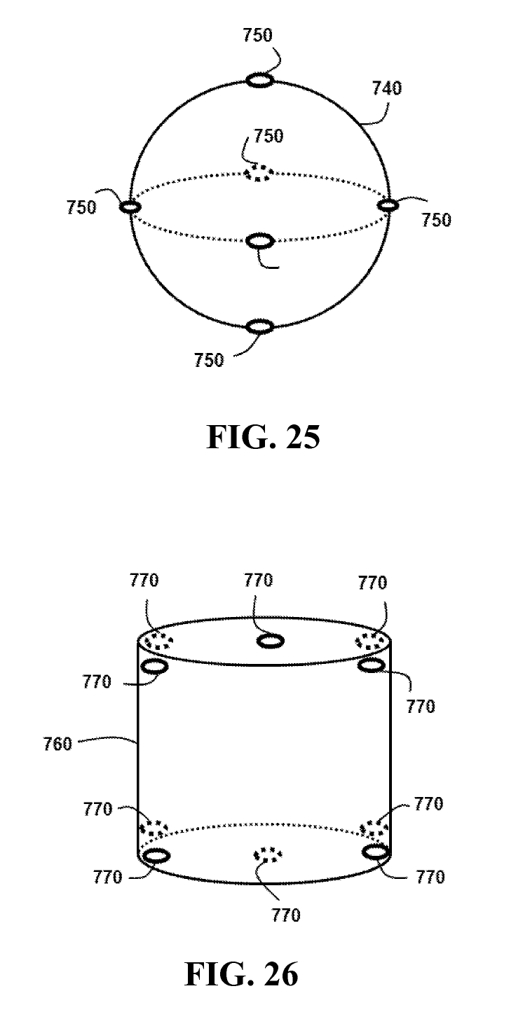

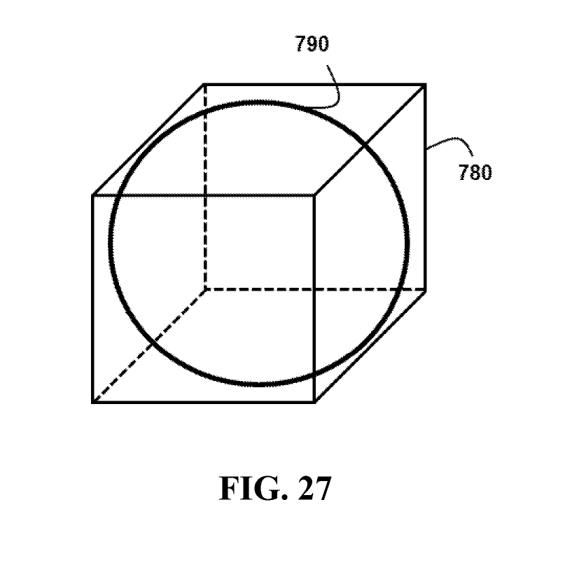

FIG. 25 illustrates a touchscreen in the form of a sphere 740 where six force sensors 750 are positioned on the sphere surface. FIG. 26 illustrates a touchscreen in the form of a cylinder 760 where ten force sensors 770 are positioned on the cylinder surfaces. FIG. 27 illustrates a three-dimensional frame 780 in the form of a cube attached to a sphere 790. The three-dimensional frame can be attached to complex three-dimensional shapes to convert them into touchscreens, akin to using two-dimensional frames with two-dimensional shapes, as shown in FIGS. 18-20.

Overall, as discussed above, a force sensing touchscreen is disclosed, while a number of exemplary aspects and embodiments have been discussed above, those skilled in the art will recognize certain modifications, permutations, additions and sub-combinations thereof. It is therefore intended that claims hereafter introduced are interpreted to include all such modifications, permutations, additions and sub-combinations as are within their true spirit and scope.

1. A touchscreen to detect the position of touch and the magnitude of a force applied to a touching panel wherein the force can be parallel, perpendicular, or sloped to the touching panel, and the touchscreen is comprised of;
a touching panel comprised of multiple surfaces attached to each other in three-dimensions;
a plurality of sensors each of which is positioned at a corner of a surface of the multiple surfaces to detect the partial force applied to the corner;
a microprocessor that receives the data of the partial forces from the plurality of sensors and determines the position of touch and the magnitude of the force.

2. The touchscreen of claim 1 wherein the touching panel has two faces and side edges and the force is applied to one of the two faces.

3. The touchscreen of claim 1 wherein each surface of the multiple surfaces is a flat surface and the multiple surfaces are attached to each other to form a three-dimensional shape.

4. The touchscreen of claim 1 wherein one or more surfaces of the multiple surfaces are curved surfaces and the multiple surfaces are attached to each other to form a three-dimensional shape.

5. The touchscreen of claim 1 wherein the plurality of sensors are force sensors.

6. The touchscreen of claim 1 wherein each sensor of the plurality of sensors detects the movement of a corresponding surface of the multiple surfaces due to the force.

7. The touchscreen of claim 1 wherein the force is multiple forces simultaneously applying to the touching panel, and the positions of touch and the magnitudes of the multiple forces are determined.

8. The touchscreen of claim 1 further the plurality of sensors are positioned at the corners of a wireframe attached to the touching panel.

9. A touchscreen to detect the centroid and resultant of multiple forces simultaneously applying to a touching panel at different positions wherein each force of the multiple forces can be parallel, perpendicular, or sloped to the touching panel, and the touchscreen is comprised of
a touching panel comprised of multiple surfaces attached to each other in three-dimensions;
a plurality of sensors each of which is positioned at a corner of a surface of the multiple surfaces to detect the partial force applied to the corner;
a microprocessor that receives the data of the partial forces from the plurality of sensors and determines the centroid and resultant of the multiple forces.

10. The touchscreen of claim 9 wherein the centroid is represented by a location on the touching panel, and the resultant is represented by a magnitude along a three-dimensional direction.

11. The touchscreen of claim 9 wherein the touching panel has two faces and side edges and the multiple forces are applied to one of the two faces.

12. The touchscreen of claim 9 wherein each surface of the multiple surfaces is a flat surface and the multiple surfaces are attached to each other to form a three-dimensional shape, and the multiple forces are applied to one or more of the multiple surfaces.

13. The touchscreen of claim 9 wherein one or more surfaces of the multiple surfaces are curved surfaces and the multiple surfaces are attached to each other to form a three-dimensional shape, and the multiple forces are applied to one or more of the multiple surfaces.

14. The touchscreen of claim 9 wherein the plurality of sensors are force sensors.

15. The touchscreen of claim 9 wherein each sensor of the plurality of sensors detects the movement of a corresponding surface of the multiple surfaces due to the multiple forces.

16. A method for determining the position of touch and magnitude of a force applied to a plurality of surfaces attached to each other at the edges in three-dimensions wherein the method comprising;
detecting the partial force at each corner of each surface of the plurality of surfaces due to the force; and
analyzing the partial forces at all corners of all surfaces of the plurality of surfaces to determine the position of touch and magnitude of the force.

17. The method of claim 16 wherein the force is multiple forces, and the position of touch is multiple positions of touch.

18. The method of claim 17 wherein the force is multiple forces, the position of touch is a centroid, and the magnitude of the force is a resultant of the multiple forces.

19. The method of claim 17 wherein the detecting of the partial forces is achieved by force sensors.

20. The method of claim 17 wherein the detecting of the partial forces is achieved by tracking the movement of the plurality of surfaces due to the force.
